(19) United States
(12) Patent Application Publication
(10) Pub. No.: US 2024/0418217 A1
(43) Pub. Date: Dec. 19, 2024

(54) THIN SECTION BEARING UNIT

(71) Applicant: Aktiebolaget SKF, Göteborg (SE)

(72) Inventors: Andrea A. BERTOLINI, Carrara (IT); Fausto BARACCA, Massa (IT); Renato BERTI, Massa (IT); Pasquale FREZZA, Aversa (CE) (IT)

(21) Appl. No.: 18/741,892

(22) Filed: Jun. 13, 2024

(30) Foreign Application Priority Data
Jun. 19, 2023 (IT) 102023000012615

(51) Int. Cl. F16C 33/66; F16C 19/16

(52) U.S. Cl. CPC F16C 33/6629; F16C 19/16

(57) ABSTRACT

A thin section bearing unit (10) for multiwire machines. The bearing unit has a central axis (A) of rotation, an inner ring (20), and a flanged rotatable outer ring (30). Defined between the inner and outer rings is a cylindrical cavity (90) for respective rolling elements (40). The inner ring (20) has an outer raceway (22) with an intermediate circumferential groove (23) containing lubricating grease for keeping the raceway (22) lubricated. The bearing unit (10) also has a hydraulic network (60) for distributing the lubricating grease for lubricating the cavity (90). The hydraulic network (60) including at least one axial duct (61) passing through the inner ring (20) and a related radial duct (62) formed in the inner ring (20) between the duct (61) and the circumferential groove (23) of the outer raceway (22).

### CROSS-REFERENCE TO RELATED APPLICATION

This application claims priority to Italian Application No. 102023000012615, filed Jun. 19, 2023, the entirety of which is hereby incorporated by reference.

### FIELD

The present disclosure relates to a thin section bearing unit.

In particular, the present disclosure relates to a thin section bearing unit for multiwire machines, to which the present description will refer without this undermining its general applicability.

### BACKGROUND

In multiwire machines, blocks of stony material, such as stone, marble, concrete and the like, are cut into slabs by the action of diamond cutting wires, which are positioned parallel to one another along a cutting path, and are drawn along this path by tensioner pulleys. In order to produce slabs of quite small thickness, the tensioner pulleys are assembled as a set, on a shared support shaft, one axially beside the other, and are rendered rotatable with respect to said support shaft by virtue of the interposition of respective thin section bearing units.

Known thin section bearing units for multiwire machines are, therefore, also mounted as a set, one beside the other along a respective shared central axis of rotation defined by the support shaft, and although their respective outside diameters are rather large, they must necessarily have a very small axial thickness to allow the tensioner pulleys to be axially mounted as close to one another as possible, while the combination of large diameters and small axial thicknesses requires particularly sophisticated technical solutions to ensure consistently high performance.

Such bearing units comprise:
respective inner rings, stationary, arranged axially right next to one another;
respective outer rings, rotatable, having an axial dimension slightly smaller than that of the related inner rings so as to be able to rotate independently of one another and allow independent rotation of the related tensioner pulleys; and
respective sealing shields arranged on the axially opposite sides of the bearing units and interposed between the related inner and outer rings, both so as to prevent contaminating materials, for example water mixed with stone dust, from getting into said bearing units, and so as to prevent the outward dispersion of the internal lubricating grease.

Each outer ring has a respective support flange connected to a related pulley, while each inner ring is delimited laterally by respective annular surfaces placed directly in contact with the annular surfaces of the inner rings of the axially adjacent bearing units.

The high level of contamination in the working environment of the bearing units described above, combined with the methods for processing the stony materials, and the poor dissipation of heat owing to the fact that said bearing units are mounted close together as a set, mean that frequent maintenance is necessary, including to prolong the service life of the bearing units. During these maintenance operations, the bearing units undergo thorough deep cleaning, despite the presence of the sealing shields, as well as almost complete reconditioning of the lubricating grease present in said bearing units since their service life depends, pretty much directly, also on the purity of this grease.

Since this maintenance involves, for the most part, disassembly of both the tensioner pulleys and the bearing units, it is in practice highly detrimental to the production efficiency of the associated multiwire machines.

### SUMMARY

It is an aim of the present disclosure to produce a thin section bearing unit which makes it possible to prolong the service life thereof without the need for particular dismantling or disassembly, or which makes it possible to lessen the frequency of the abovementioned maintenance, entirely to the benefit of the production efficiency of the associated multiwire machines.

A thin section bearing unit according to the present disclosure has the features set out in the attached claims.

### BRIEF DESCRIPTION OF THE DRAWINGS

The present disclosure will now be described with reference to the attached drawings, which illustrate a non-limiting embodiment of the present disclosure, in which:

FIG. 1 is a view in side elevation of a preferred embodiment of the thin section bearing unit of the present disclosure;

FIGS. 2 and 3 are cross sections along the lines II-II and III-III in FIG. 1; and

FIG. 4 shows a set of thin section bearing units produced using the thin section bearing unit of FIG. 1.

### DETAILED DESCRIPTION

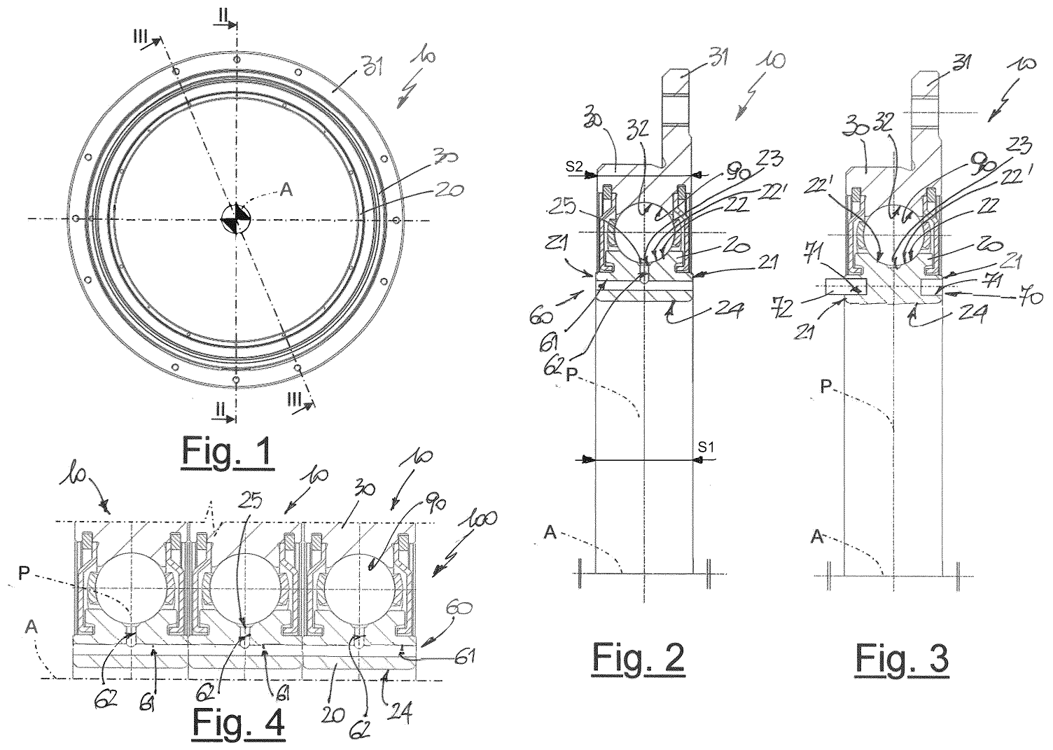

With reference to FIG. 1, the reference numeral 10 generally designates a bearing unit having a thin section which, therefore, takes up very little space axially such that it can be mounted, as shown in FIG. 4, together with other identical bearing units 10, as a set 100 of bearing units 10, wherein the set 100 may include from thirty up to one hundred, or even one hundred and fifteen, bearing units 10 placed side by side along a respective shared central axis of rotation A.

The thin section bearing unit 10 of the present disclosure may advantageously be used in multiwire machines, to which the following description will refer, by way of example, without this undermining its general applicability. In such multiwire machines, blocks of stony material are cut into slabs by the action of diamond cutting wires, positioned parallel to one another along said blocks, and drawn across these blocks by tensioner pulleys (not shown). To produce these slabs, said tensioner pulleys are assembled as a set, one axially beside the other, on a shared support shaft (not shown) defining the central axis A, and are rendered rotatable with respect to the support shaft by virtue of the interposition of a respective bearing unit 10.

As shown in FIG. 2, the bearing unit 10 comprises:
an inner ring 20, stationary, mounted on the stationary shaft and limited axially by respective annular surfaces 21 that are transverse to the axis A;
a flanged outer ring 30, rotatable, having an axial thickness S2 of dimensions smaller than the axial dimensions of an axial thickness S1 of the inner ring 20 and defining with the inner ring 20 a cylindrical cavity 90;
a plurality of rolling elements 40, preferably balls, arranged inside the cavity 90 and interposed between the inner ring 20 and the outer ring 30 so as to allow relative rotation thereof about the axis A; and
two sealing shields 50 arranged on the axially opposite sides of the bearing unit 10 and interposed between the inner ring 20 and the outer ring 30, both so as to prevent contaminating materials, for example water mixed with stone dust, from getting into the cavity 90 of said bearing unit 10, and so as to prevent the outward dispersion of the lubricating grease contained inside the cavity 90.

The inner ring 20 and the outer ring 30 are provided, respectively, with an outer raceway 22 and an inner raceway 32, radially facing one another and the cavity 90, in which the rolling elements 40 may roll, while the outer ring 30 also has a support flange 31, which extends radially outward from said outer ring 30 in a direction transverse to the axis A, and is connected to a related pulley of the multiwire machine.

The inner ring 20 is delimited radially internally by a cylindrical surface 24 which is coaxial with the axis A and orthogonal to the two annular surfaces 21 which, when the bearing unit 10 is mounted as a set together with other identical bearing units 10, are placed in direct contact with the annular surfaces 21 of the inner rings 20 of the axially adjacent bearing units 10. In the bearing unit 10 according to the present disclosure, the ratio between an inside diameter of the surface 24 and the axial thickness S1 of the inner ring 20 ranges from a minimum of 8 to a maximum of 12. The inner ring 20 also has, on the outer raceway 22, a circumferential groove 23 which splits the raceway 22 into two annular portions 22′ that mirror one another about a plane P of symmetry of the rolling elements 40 perpendicular to the axis A.

The circumferential groove 23 duly contains lubricating grease for keeping the raceway 22 lubricated and, precisely for the purposes of topping up this lubricating grease so as to prolong the service life of the bearing unit 10 without having to necessarily remove and/or disassemble said bearing unit 10, the latter further comprises a hydraulic network 60 for distributing the lubricating grease.

The hydraulic network 60 makes it possible to distribute fresh lubricating grease inside the bearing unit 10, and comprises at least one axial duct 61 passing through the inner ring 20 parallel to the axis A, and a related radial duct 62 formed in the inner ring 20 between the duct 61 and a cylindrical bottom 25 of the circumferential groove 23.

The axial duct 61 is formed between the circumferential groove 23 and the cylindrical surface 24 in a position that is radially closer to the cylindrical surface 24 than to the cylindrical bottom 25 of the circumferential groove 23 so as to avoid affecting the performance or characteristics of the bearing unit 10 in any way, and is also formed through the two surfaces 21 so as to connect the two axially opposite sides of the bearing unit 10 to one another. The axial duct 61 and the radial duct 62 have a diameter with dimensions between 1.5 mm and 1.75 mm so as to allow enough of the lubricating grease injected therein, as explained more fully below, either using manual pumps or by means of automated systems on a timer, to flow from outside the bearing unit 10 into the cavity 90.

As stated above, the thin section bearing unit 10 has a rather large outside diameter and, therefore, in order to help distribute the injected lubricating grease as homogeneously as possible, the hydraulic network 60 comprises up to eight ducts 61, and one duct 62 for each duct 61, which are uniformly distributed around the axis A and, when there are eight of them as in the embodiment illustrated here, are arranged at 45° from one another.

With reference to the preferred embodiment shown in FIGS. 1 and 2, all eight ducts 61 are parallel to the axis A and have, like all eight ducts 62, a diameter having dimensions of between 1.5 mm and 1.75 mm so as to ensure that enough of the lubricating grease injected therein can flow from outside the bearing unit 10 into the cavity 90 and around the whole circumference of the circumferential groove 23.

The diameter chosen for the ducts 61 and 62, like the number of ducts 61 and 62 chosen per bearing unit 10, will depend essentially on the operating conditions, the type of lubricating grease preferred for those operating conditions and also essentially on the number of bearings units 10 per set 100.

This is because, as repeatedly emphasized above, the bearing unit 10 according to the present disclosure is intended to be always mounted, together with other identical bearing units 10, as a set 100 containing from thirty up to one hundred, or even one hundred and fifteen, bearing units 10 and, in this type of installation, in order to ensure that even the bearing units 10 positioned towards the centre of the set 100 receive the necessary quantity of lubricating grease, it is absolutely vital that the ducts 61 of each bearing unit 10 be perfectly aligned with the ducts 61 of the immediately adjacent bearing units 10.

To this end, as shown in FIG. 3, the bearing unit 10 comprises one or more pairs 70 of centring blind holes 71, which are parallel to the axis A, and extend from the surfaces 21 towards the inside of the inner ring 20. The blind holes 71 of each pair 70 of blind holes 71 are aligned with one another, and have a diameter with dimensions that are greater than the dimensions of the diameter of the ducts 61 and, preferably, dimensions equal to 2.5 mm. The pairs 70 of blind holes 71 are also positioned radially closer to the cylindrical surface 24 than to the raceway 22 and, given the dimensions of the diameter of the holes 71, they have however a limited axial depth, preferably no more than 4 mm, such that they do not axially overlap said raceway 22 so as to avoid affecting the performance or characteristics thereof in any way.

The bearing unit 10 further comprises, for each pair 70 of blind holes 71, a peg 72, which has an axial length no more than double the axial depth of said hole 71, and when two bearing units 10 are placed side by side, is inserted in the axially facing blind holes 71 of the two bearing units 10 so as to perfectly align all the ducts 61.

Again given that the thin section bearing unit 10 has a rather large outside diameter, and since the hydraulic network 60 comprises up to eight ducts 61, the bearing unit 10 may also comprise up to eight pairs 70 of centring blind holes 71, which are uniformly distributed around the axis A and, when there are eight of them as in the embodiment illustrated here, are arranged at 45° from one another in angular positions alternating with the ducts 61.

Referring now specifically to FIG. 4, note that while the hydraulic network 60 does comprise at least one axial duct 61 and one radial duct 62 for each bearing unit 10, in the set 100, it comprises all the axial ducts 61 and all the radial ducts 62 of all the bearing units 10 of the set 100, wherein the axial ducts 61 of the inner bearing units 10 are connected to the axial ducts 61 of the immediately neighbouring bearing units 10, while the ducts 61 of the axially outer bearing units 10 will be connected either to manual pumps for manually injecting the lubricating grease into the hydraulic network 60, or to automated systems on a timer that are suitable for automatically injecting the lubricating grease into the hydraulic network 60.

The greater the size of the set 100 of bearing units 10, the greater the care that will have to be taken to be able to send the right amount of lubricating grease also to said bearing units 10, on the basis of suitable dimensioning of the dimensions of the diameters of the ducts 61 and 62 within the range indicated, even considering lubricating greases with particular viscosities or with specific injection temperatures to make them viscous as required and to allow them to flow from one duct 61 to the next until they reach the cavities 90 of the bearing units 10 that are axially furthest away from the outside.

It is clear from the above that with the bearing unit 10 of the present disclosure it will no longer be necessary to carry out frequent maintenance since relubrication of the bearing units 10 may be carried out directly without shutting down the multiwire machines concerned, entirely to the benefit of both the productivity of said multiwire machines and the service life of the bearing units 10.

In addition to the embodiments of the present disclosure as described above, it is to be understood that there are numerous other variants. It is also to be understood that said embodiments are merely examples and do not limit the subject matter of the present disclosure, its applications, or its possible configurations. On the contrary, although the above description enables those skilled in the art to apply the present disclosure according to at least one exemplary configuration thereof, it is to be understood that numerous variations of the components described may be devised, without thereby departing from the subject matter of the present disclosure as defined in the appended claims, interpreted literally and/or according to their legal equivalents.

What is claimed is:

1. A thin section bearing unit for multiwire machines, the bearing unit having a central axis of rotation, and comprising:
a stationary inner ring, which is delimited axially by respective annular surfaces that are transverse to the central axis of rotation and is further delimited, radially internally, by a cylindrical surface which is coaxial with the central axis of rotation and, radially externally, by an outer raceway;
a flanged rotatable outer ring, of axial dimensions smaller than an axial dimension of the inner ring and defining with said inner ring a cylindrical cavity; and
a plurality of rolling elements arranged inside the cavity and interposed between the inner ring and the outer ring so as to allow relative rotation thereof about the central axis of rotation;
a hydraulic network for distributing the lubricating grease for lubricating the cavity and comprising at least one axial duct passing through the inner ring parallel to the central axis of rotation, and a related radial duct formed in the inner ring between the axial duct and the outer raceway.

2. The thin section bearing unit according to claim 1, wherein the axial duct is formed between the two surfaces so as to connect two axially opposite sides of the bearing unit to one another and between the outer raceway and the cylindrical surface in a position that is radially closer to the cylindrical surface than to the outer raceway so as to avoid affecting the performance or characteristics of the bearing unit.

3. The thin section bearing unit according to claim 2, wherein the outer raceway comprises a circumferential groove which splits the raceway into two annular portions that mirror one another about a plane of symmetry of the rolling elements perpendicular to the central axis of rotation, and contains lubricating grease for keeping the raceway lubricated: the radial duct opening into the groove through a bottom of said groove so as to top up this lubricating grease and prolong the service life of the bearing unit.

4. The thin section bearing unit according to claim 3, wherein the hydraulic network for distributing the lubricating grease comprises up to eight axial ducts, and one axial duct for each radial duct, wherein the axial ducts are uniformly distributed around the central axis of rotation, and, when there are eight of them, are arranged at 45° from one another.

5. The thin section bearing unit according to claim 4, wherein the thin section bearing unit takes up very little space axially such that the this section bearing unit can be mounted together with other identical thin section bearing units, as a set of thin section bearing units, wherein the set includes a predetermined number of thin section bearing units ranging from a minimum of 30 up to a maximum of at least 115, and wherein the thin section bearing units are assembled side by side along the central axis of rotation and with the related annular surfaces of the central inner rings placed directly in contact with one another.

6. The thin section bearing unit according to claim 5, wherein the hydraulic network comprises, in the set, all the axial ducts and all the radial ducts of all the bearing units, wherein the axial ducts of the thin section bearing units internal to the set are connected to the axial ducts of the immediately neighbouring thin section bearing units, while the axial ducts of the axially outer thin section bearing units will be connected to means for injecting lubricating grease into the hydraulic network.

7. The thin section bearing unit according to claim 6, further comprising centring means for axially centring the axial ducts of the hydraulic network of the set; the centring means comprising one or more pairs of centring blind holes, which are parallel to the central axis of rotation, and extend from the surfaces towards the inside of the inner ring, and, for each pair of centring blind holes, a peg having an axial length no more than double the axial depth of said hole.

8. The thin section bearing unit according to claim 7, wherein the centring blind holes have a limited axial depth such that they do not axially overlap said raceway so as to avoid affecting the performance or characteristics thereof in any way.

9. The thin section bearing unit according to claim 1, wherein the outer ring has a support flange which extends radially outward from said outer ring in a direction transverse to the central axis of rotation, and is connected to a respective pulley of the multiwire machine.
